(19) United States
(12) Patent Application Publication
(10) Pub. No.: US 2023/0012415 A1
(43) Pub. Date: Jan. 12, 2023

(54) Method for Controlling a Kitchen Appliance System

(71) Applicant: Vorwerk & Co. Interholding GmbH, Wuppertal (DE)

(72) Inventors: Matthias Stein, Mülheim an der Ruhr (DE); Andreas Uhlenbrock, München (DE); Kristina Ott, Berlin (DE); Ingo Dering, Wermelskirchen (DE); Michael Abels, Pulheim (DE)

(21) Appl. No.: 17/752,126

(22) Filed: May 24, 2022

(30) Foreign Application Priority Data
May 28, 2021 (EP) 21 176 542.5

(51) Int. Cl. A47J 36/32; G05B 19/042

(52) U.S. Cl. CPC A47J 36/32; G05B 19/042; G05B 2219/2643

(57) ABSTRACT

The invention relates to a method for controlling a kitchen appliance system (100), preferably for automatically processing at least one working stage (12.1) of a recipe (12) for preparing a dish (11), with the aid of a central control device (15) having at least one user input device (15.2) and an interface (15.3), the kitchen appliance system (100) comprising at least two kitchen appliances (10) which are entered in an appliance list and each kitchen appliance (10) from the appliance list having an interface (10.9), whereby this can be controlled by the central control device (15), wherein each kitchen appliance (10) has at least one appliance function (10.7), which can be selected and/or set by at least one parameter (10.8), in order to carry out at least one working stage (12.1) from the recipe (12) for the preparation of the food (11) automatically by the respective appliance function (10.7) of the kitchen appliance (10). According to the invention, it is provided that the user input device (15.2) has a user interface (16) for displaying and controlling the method, the user interface (16) having at least one foldable and unfoldable overview panel (18) which, in the folded state (I) of the overview panel (18), displays parameters (10.8) of a kitchen appliance (10) of the kitchen appliance system (100) and, in an unfolded state (II) of the overview panel (18), displays at least partially or the entire appliance list of the kitchen appliance system (100), wherein parameters (10.8) of at least each active kitchen appliance (10) with the respective appliance function (10.7) are displayed. Furthermore, the invention is also directed to a device for controlling a kitchen appliance system (100), preferably for automatically processing at least one stage (12.1) of a recipe (12) for preparing a food (11).

The present invention is directed to a method for controlling a kitchen appliance system comprising at least two kitchen appliances, preferably for automatically executing at least one working stage of a recipe for a preparation of a food according to the generic term of the independent method claim. Furthermore, the invention also comprises a device for controlling a kitchen appliance system comprising at least two kitchen appliances, preferably for automatically processing at least one working stage of a recipe for a preparation of a food according to the independent device claim. Furthermore, the present invention is also directed to computer program product according to the corresponding claim for carrying out the method according to the invention.

Household kitchen appliances with complex functions, such as cooking, stirring, weighing, timing, etc., that can access digital recipes for semi-automated preparation of a dish are known. To prepare a dish, a user works successively through the recipe stages in the order specified by the recipe, as when cooking according to a recipe in a cookbook. It is also known from the prior art that the functionalities of different kitchen appliances can be used in a manual or partially automated manner in a complementary manner. For example, various appliances are present in a kitchen for providing functions for the preparation of food. When preparing food according to a recipe, a user uses these different kitchen appliances according to the individual recipe stages, so that, for example, a food is first chopped and cooked in a kitchen appliance and then cooked with another food in an oven.

Such kitchen appliances can be interconnected to form a kitchen appliance system by networking to achieve semi-automated preparation of the desired food beyond one appliance. In this case, the operation of the existing appliances is complex and difficult due to the complexity of the system, especially when there is only a small display to control the process and a large number of kitchen appliances to be coordinated. Thus, depending on the recipe stage in the recipe, the various kitchen appliances must perform the respective next stage on the corresponding kitchen appliance, whereby the sequence is confused quickly by manual intermediate stages, such as the addition of spices or water. This means that the user has to initiate the next working stage according to the recipe on the one hand and according to the kitchen appliance on the other, which in some cases involves a considerable amount of checking and/or searching for the user to ensure that the required sequence of working stages is adhered to.

It is therefore an object of the present invention to at least partially eliminate the disadvantages described above. In particular, it is an object of the present invention to improve the overview for a user as well as the control of the kitchen appliance system and, if necessary, of the individual kitchen appliances, in particular during the processing of a recipe.

The foregoing problem is solved by a method for controlling a kitchen appliance system having the features of the independent method claim, by an apparatus for controlling a kitchen appliance system having the features of the subsidiary apparatus claim, and by a computer program product having the features of the corresponding claim. Further features and details of the invention result from the respective dependent claims, the description and the drawings. Features and details described in connection with the method according to the invention naturally also apply in connection with the device according to the invention as well as the computer program product according to the invention, and vice versa in each case, so that with respect to the disclosure concerning the individual aspects of the invention reference is or can always be made mutually.

The object is solved in particular by a method for controlling a kitchen appliance system, preferably for the automatic execution of at least one working stage/step of a recipe for a preparation of a meal, with the aid of a central control device with at least one user input device and a (data) interface. Thereby, the kitchen appliance system comprises at least two kitchen appliances, which are entered in a (digital) appliance list and each kitchen appliance from the appliance list has a (data) interface, whereby this can be controlled by the central control device, and wherein each kitchen appliance has at least one appliance function, which can be selected and/or set by at least one parameter, in order to automatically execute at least one working stage from the recipe for the preparation of the food by the respective appliance function of the kitchen appliance. For this purpose, a (digital and stored) recipe list may be present in which at least two recipes are present, each recipe having corresponding working stages for preparing the food. By preparation of a food in the sense of the present invention is also understood the preparation of a beverage or a foodstuff or a dough or an ice cream or the like. According to the invention, it is provided that the user input device comprises a user interface for displaying and controlling the method, wherein the user interface itself comprises at least one foldable and unfoldable overview panel which, in the folded state of the overview panel, displays parameters of (only) one kitchen appliance of the kitchen appliance system (with its current appliance functions) and, in an unfolded state of the overview panel, displays at least partially or the entire appliance list of the kitchen appliance system, wherein (preferably simultaneously) parameters of at least each active kitchen appliance with the respective appliance function are displayed. An active kitchen appliance (from the appliance list) is understood to mean that it is switched on and can be reached by the control method via the existing interface in terms of data technology, so that the parameters can thus be exchanged.

The folded and unfolded overview panel allows the optimum overview of all kitchen appliances of the kitchen appliance system to be achieved even with a geometrically small user interface (for a small display), in order to achieve optimum control for the user. Also the control of the working stages for the preparation of the food is particularly simple for the user, since he reaches over the folding and unfolding of the overview panel at any time fast and without large expenditure to the desired kitchen appliance, in order to be able to initiate and/or execute there the next working stage (from the recipe). It is to be clarified at this point that also in the folded condition of the overview panel, the overview panel remains with a minimum size on the user interface, in order to indicate the condition of (exclusively) a kitchen appliance with the appropriate parameters. Also, the folding and unfolding overview panel can be permanently displayed on the user interface (for optimal control for the user).

The term: control or controlling, in the sense of the invention, is intended to encompass the meaning of controlling and regulating, where preferably the control is automatic.

Recipe preferably means a digital recipe that is combined with other recipes in the recipe list. A digital recipe is also a data record that defines several working stages for an electrically operable functional component of the kitchen appliance, a so-called appliance function. The definition of the working stages includes at least one start condition in each case. In addition, control commands in the form of parameters for one or more electrically operable functional components of the kitchen appliance or appliance functions are assigned to each working stage. Optionally, the definition of the recipe may additionally comprise methods or algorithms by means of which the control device can determine whether a start condition is fulfilled as a function of at least one measured parameter. In particular, the definition may include prioritization information and/or a prioritization algorithm (in the form of data), for example, to shorten the time required to process the stages or to reduce the amount of work required by the user.

The central control device has at least the user input device and an interface for communication with other devices, preferably kitchen appliances. The central control device can be a separate unit or distributed with its units in a higher-level device. The user input device comprises at least a display and an input device, which may also be combined, for example in the case of a touch screen. Also, the display and the input device (e.g., buttons, keyboard, mouse, multifunction knob preferably rotatable, swiveling and pressable, joystick, touch pad) can be designed separately from each other. Furthermore, the central control device ideally also has a data memory for pure data (e.g. in the form of parameters) and executable program codes, and a data processing unit, in particular a microprocessor for automatic processing of the program code.

The appliance list is a data list in which the accessible and/or controllable kitchen appliance of the kitchen appliance system are stored. The appliance list and/or the recipe list may also be stored in the data memory of the central control device. Expediently, the kitchen appliances have at least authenticated, authentified or authorized themselves to be entered in the appliance list (see below). These measures are intended to prevent manipulation and misuse.

The term: parameter is understood to mean a preferably bidirectional data set that controls or regulates the specific functional component or device function of a kitchen appliance, whereby input and output data for operating the device function may also be present in addition to the device function, for example:
a) Heating (e.g. from stove, oven, cooking appliance etc.), set temperature and actual temperature, heating duration, fan etc.
b) Heating operation of a heater with heating zone and heating mode
c) Agitator from mixer, target speed and actual speed, direction of rotation, interruptions, duration, etc.
d) Oven lighting, switch on
e) Temperature of an auxiliary thermometer.

With the additional thermometer (point e), the device function is only the actual temperature of the thermometer, which can be queried as a parameter and thus displayed.

The kitchen appliance can be an appliance with only one appliance function, e.g. thermometer, or an appliance with many complex functions, e.g. food processors with at least partially automated or fully automated appliance functions for fully automatic preparation of food. Also, for example, a blender, a toaster, a coffee maker, a stove, an oven, a microwave, a refrigerator, an extractor hood, a kettle, electric pan or pot can be considered as a kitchen appliance.

Further, it is conceivable that at least one of the kitchen appliances is embodied as a miscellaneous appliance, such as a music system, a television, a computer, a lighting unit, or the like.

Preferably, the kitchen appliances are designed completely separately and/or spatially spaced apart from each other. They are thus separate kitchen appliances which are connected to each other, for example, only via an interface, in order to exchange data, in particular, at least in the form of the parameters mentioned. Preferably, each appliance comprises electronics which operate independently of one another. In particular, all devices are different and/or structurally separate (not in one housing) from each other.

It is also possible within the scope of the invention that in the fold-in state of the overview panel of only one kitchen appliance of the kitchen appliance system exclusively parameters about at least one current (meant is: temporally just executed) appliance function, preferably:
Time indication, especially about the remaining time of the device function
Temperature, in particular setpoint and/or actual temperature
Weight and/or type of food
Stirring function, especially stirring stage or speed
Heating operation at the furnace
Moisture specification
Fan operation
Filling level (coffee machine water/coffee/milk)
Consumption level etc.
   (symbolized in one line) is displayed. This gives the user a direct overview of the most important information in the current preparation process for the dish.

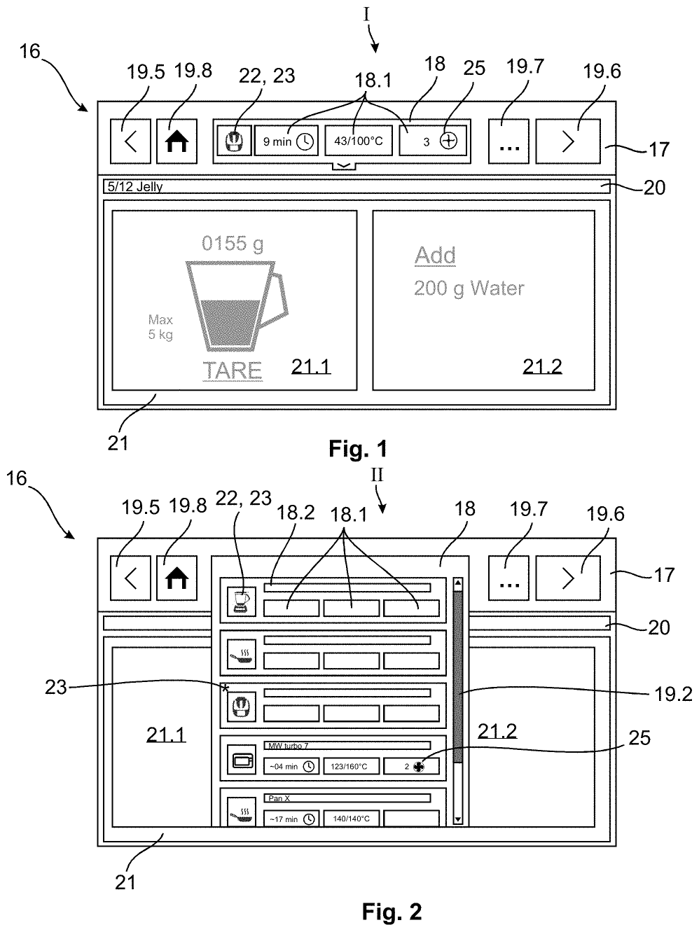

In an unfolded state of the overview panel, on the other hand, the appliance list of the kitchen appliance system (with all kitchen appliances present in the appliance list) can be displayed, whereby each kitchen appliance from the appliance list can be symbolized with an icon or each kitchen appliance of an appliance class can be symbolized with a uniform icon (for example, all ovens have a uniform oven icon or each mixer has a uniform mixer icon, see FIG. 2) and can have an appliance name. Preferably, the parameters of each kitchen appliance with the respective appliance function can be displayed simultaneously in sections, in particular line by line one below the other or block by block side by side and one below the other, (visually combined). This gives the user a complete overview of all kitchen appliances with their respective current (currently executed) appliance functions. Furthermore, other visual concepts for the unfolded overview panel are conceivable as follows:
Kanban board
Gant diagram
Flowchart
“Subway” timetable,
   to give an improved overview. The recipe display (see FIG. 7) with its respective working stages for the respective kitchen appliances can also be carried out according to the same principle.

If the user now wants to manually control a special kitchen appliance (for the next working stage or for control purposes), he can do so by selecting and confirming the corresponding kitchen appliance in the unfolded overview panel. However, if the special kitchen appliance is already displayed in the folded overview panel, the user can select it directly there. If the user input device is a touch screen (touch-sensitive display), the selection and confirmation of the corresponding kitchen appliance is done by touching the displayed (and selected) kitchen appliance in the unfolded overview panel. Otherwise, the selection and confirmation of the corresponding kitchen appliance in the unfolded overview panel can be done via a key- or mouse-controlled cursor. After selecting and confirming the corresponding kitchen appliance, the unfolded overview panel can automatically switch to the folded overview panel, where the selected kitchen appliance is now automatically displayed with its current (currently executed) appliance functions. If the user now wants to manually select a specific kitchen appliance (for the next working stage or for control purposes), which is currently not shown in the folded overview panel, he can reach it by selecting and confirming the entire (or only a part of the) overview panel, which causes a change to the folded overview panel with the corresponding kitchen appliance. As will be mentioned later, an automatic change of the state of the overview panel and/or the displayed kitchen appliance in the folded overview panel and/or the order of the displayed kitchen appliances unfolded overview panel can also take place.

It is also conceivable according to the invention that for each kitchen appliance in the appliance list at least one activation marker is displayed in the foldable and unfoldable overview panel, the activation marker indicating whether at least
the kitchen appliance can be reached and/or controlled by the method
the kitchen appliance is switched on or off
at least one device function of the kitchen appliance is active.

The activation marker allows the user to immediately and intuitively recognize the current status of the kitchen appliance through the overview panel without having to additionally query this from the corresponding device, which significantly simplifies the operation of the system. Preferably, the respective icon of the kitchen appliance also serves as an activation marker, e.g. the coloring of the icon can provide direct information, e.g. green—kitchen appliance is active, yellow—kitchen appliance is switched on but inactive, red—kitchen appliance cannot be reached and/or controlled by the process. Instead of the color of the icon, a background of the icon or a complete or partial inversion of the icon as an activation marker can also provide information about the current state of the appliance. The user can also use a selection of the activation marker to specify which kitchen appliances are displayed with priority.

Furthermore, it can be provided that a change (a) between the folded and the unfolded state of the overview panel and/or (b) of the displayed kitchen appliance in the folded overview panel and/or (c) of the sequence of the displayed kitchen appliances in the unfolded overview panel is effected by an activation, wherein the activation can be triggered by a manual selection and/or a trigger signal and/or by an incoming warning signal from a kitchen appliance and/or time-dependently. The manual selection for a change at the overview panel has already been described. A trigger signal can be generated, for example, by reaching a target of a working stage (from the recipe), by a time lapse of a timer, by reaching a desired temperature or solidity of the food, by reaching a speed and/or expiration of a heating phase, whereby a change at the overview panel can be achieved automatically. An incoming warning signal can also achieve an automatic change at the overview panel, where the warning signal can be generated, for example, by a temperature overrun, a time overrun, a safety device (e.g. lid missing), a missing rotation, etc. Also, an incoming trigger signal and/or warning signal from a kitchen appliance can change the overview panel in such a way that the corresponding kitchen appliance is displayed with a warning indication (e.g. flashing icon or red triangle behind the icon) preferentially, in particular with its (critical/alarm) appliance function automatically.

Furthermore, it is possible for several kitchen appliances to be combined into at least one appliance class, whereby the appliance list with the available appliance class is displayed (by marking or in areas) preferably in the unfolded state of the overview panel. This allows the user to immediately see whether optional devices are available for a working stage or device function. Also, all devices in a device class can be displayed preferably with the respective device function, which further improves the overview for a user.

In the collapsed state of the overview panel, the kitchen appliance may be displayed by an adjustable first mode that is adjustable by a user or predefined. The first mode may include the following:
1. Mode—main device is displayed prioritized, where the main device is selected and determined by the user from the active kitchen appliances
2. Mode—the currently active kitchen appliance
3. Mode—the kitchen appliance with the next manual stage/step for a user.
4. Mode—the active kitchen appliance with the shortest remaining time of a working stage.
5. Mode—the kitchen appliance with a warning or error message.
6. Mode—the kitchen appliance after prioritization, for example, manual monitoring by user required.

The first mode can be freely selected and set by the user, so that he always gets the desired device (after his selection of the mode) displayed in the folded state of the overview panel. In this way, the user always has an optimal overview of the current process status in the preparation of his food. It is also conceivable that the 1st mode is predefined (in software and/or by the manufacturer) by the kitchen appliance manufacturer and thus cannot be changed by the user.

It is also conceivable that in the unfolded state of the overview panel, the device list can be displayed in a (user) adjustable or already predefined second mode, where the order of the devices in a
1. Mode the devices according to device classes,
2. Mode the devices according to their activity
3. Mode the devices according to a prioritization,
4. Mode the devices according to a (time) sequence of the next working stages from the recipe and
5. Mode the devices after a warning signal
   can be displayed. The second mode can also be predefined by the kitchen appliance manufacturer (in terms of software and/or manufacturer) and thus be unchangeably set for a user.

By using the different modes, the overview of the control process can be improved for the user. The better overview also helps him to work through the next stages for preparing his food. Here, the mode (free for the user) can be selectable (e.g. via an option key/input key option) and the order of the displayed devices (even from top to bottom or from bottom to top) can be changed. In this way, the user can easily configure his or her own desired view of the overview panel.

For example, the first and second adjustable modes may be accessible and selectable (only) by preselecting the respective state of the overview panel.

It can also be provided that the user interface, in addition to the foldable and unfoldable overview panel, also has at least one control panel for at least one appliance function of the kitchen appliance, wherein preferably the control panel of the kitchen appliance and the folded overview panel (with the kitchen appliance) are displayed simultaneously (and completely), for an optimal overview. Ideally, the control panel is further divided into at least a status panel and an instruction panel. In the status panel, the state of the respective kitchen appliance can be displayed in detail (partially or completely) with its current parameters, warnings, etc. Whereas in the instruction panel at least one parameter of the respective kitchen appliance (from the status panel) can be changed and controlled by the user. The control panel is usually overlapped by the unfolded overview panel to allow easy and quick change of the kitchen appliance.

In order to facilitate the operation of the method, it may be provided that the user interface of the user input device displays individual panels (such as also overview panel, main information panel, control panel, operation panel, etc.) which at the same time serve as input keys and/or scroll bars for the control of the method by the central control device, whereby at least one device function of a kitchen appliance is triggered on the basis of input parameters which have been entered with the aid of the user interface. In other words, the selection and activation of a panel on the user interface triggers a working stage in the background, which is usually stored as executable program code (computer program) in the control device, preferably in a (data) memory, and is then executed in a data processing unit, in particular a microprocessor. Values can also be entered or functions, devices and the like can be selected via these panels.

To improve the overview, it is also possible for the user interface to have a main information panel with control panels for the process, with the overview panel being integrated in the main information panel when folded. In this way, a particularly space-saving arrangement with optimum operability and overview can be achieved. Furthermore, the control panel can be displayed together next to, preferably below, the main information panel in order to achieve intuitive operation for the user.

As already mentioned, the overview panel can at least partially overlap the control panel when it is unfolded in order to make it easy to select the kitchen appliance to be controlled from the appliance list.

To enable data exchange in the kitchen appliance system, it is conceivable that the (data) interface of the respective kitchen appliance is designed as a wireless interface, whereby in particular the interface is designed as a short-range radio technology interface or local wireless network connection interface, in particular in the form of WLAN (according to the standard of the IEEE 802.11 family), Wi-Fi, UWB (ultra-wide band) or Bluetooth interface. The WLAN or WiFi interface offers the advantage of fast data exchange even over long distances. It can also be used to connect directly to a network, for example to access the Internet or to control the process via other devices. The Bluetooth interface makes it particularly easy to establish a data connection between the devices. Furthermore, a protected and encrypted data exchange should preferably be carried out via the interfaces in order to avoid manipulations. For this purpose, it is appropriate that the kitchen appliances ideally authenticate (proof of a certain identity), authentified (verification of this proof of identity), authorize (granting access to privileges) and/or exchange a key to encrypt the data. Especially for device functions that are hazardous to the body, high security of the data connection is extremely important to avoid hazards.

Also, the present invention is directed to a device for controlling a kitchen appliance system (according to the independent device claim), preferably for automatically executing at least one stage of a recipe for preparing a meal, comprising a central control device and at least one user input device and a (data) interface, wherein the central control device is adapted to execute the method according to the preceding claims. Thus, the device according to the invention benefits from the same advantages that have already been described with respect to the method. In this context, the device itself can be designed as a kitchen appliance or be integrated therein.

The corresponding kitchen appliance can have at least one container for the preparation of the food, an agitator which protrudes into the container, and the central control device with at least the user input device and the (data) interface, in order to already be able to carry out some appliance functions itself. Furthermore, the kitchen appliance may have a heater to be able to heat the container or the contents in the container. Furthermore, the kitchen appliance can have a scale in order to be able to easily determine the weight of the food to be fed for food preparation. Based on the weight, the recipe can also be adjusted automatically by the control device using appropriate methods and algorithms (e.g. food is prepared for 3 people instead of 2).

It is also conceivable that the device itself is designed as a computer, laptop, tablet, smart phone or smart TV. These devices are particularly suitable for forming the central control device with its user input device and interface. Thereby, these devices also have a data memory for the program code (computer program) and the data processing unit, in particular a microprocessor, to process the program code, whereby overall the method according to the invention is particularly easy to implement. The input as well as the reading of data for the parameters as well as the acquisition of data (of the measured parameters) via the interface is thus also convenient.

Finally, the invention also includes a computer program product comprising instructions that cause the device according to the invention to perform the method according to the invention, in particular the required method stages. Furthermore, the invention is also directed to a data storage device comprising the computer program product.

Further measures and advantages of the present invention result from the claims, the following description and the drawings. Likewise, the disclosed features from the device according to the invention also apply to the method according to the invention and vice versa. In the drawings, the invention is illustrated in different embodiments. In this connection, the features mentioned in the claims and in the description may each be essential to the invention individually or in any combination. They show:

FIG. 1 Schematic representation of a user interface with a folded overview panel,

FIG. 2 Similar representation of the user interface from FIG. 1, but with an unfolded overview panel,

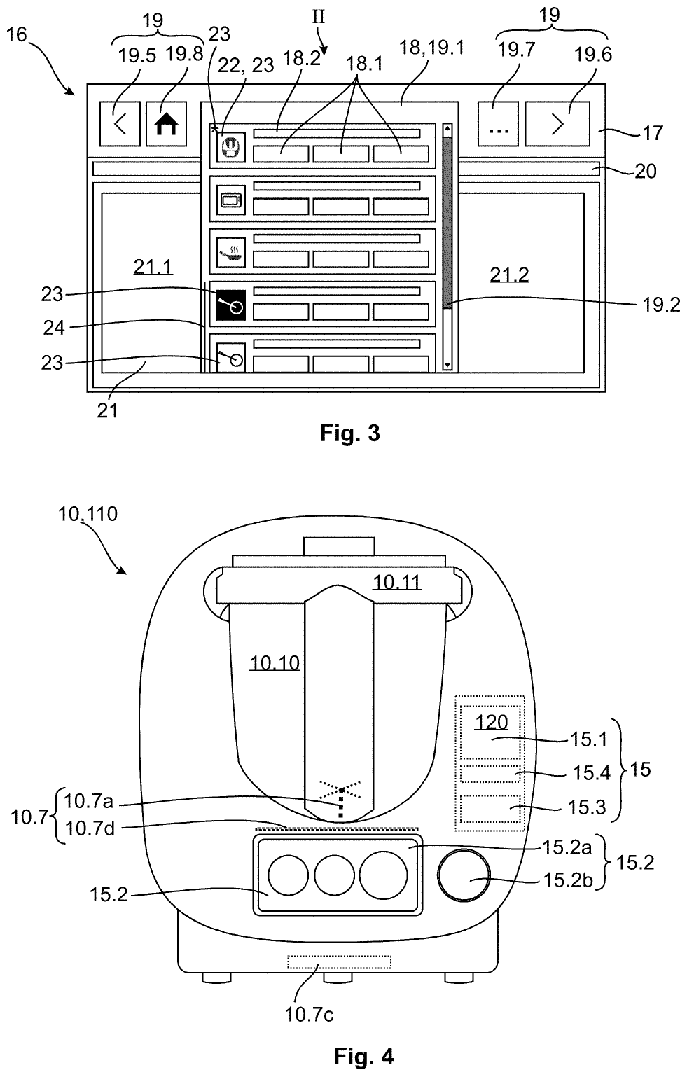

FIG. 3 Similar user interface as in FIG. 2, with different activation markers in the expanded overview panel,

FIG. 4 Schematic representation of a device according to the invention, in the form of a kitchen appliance with an (integrated) central control device, the kitchen appliance being equipped with complex functions,

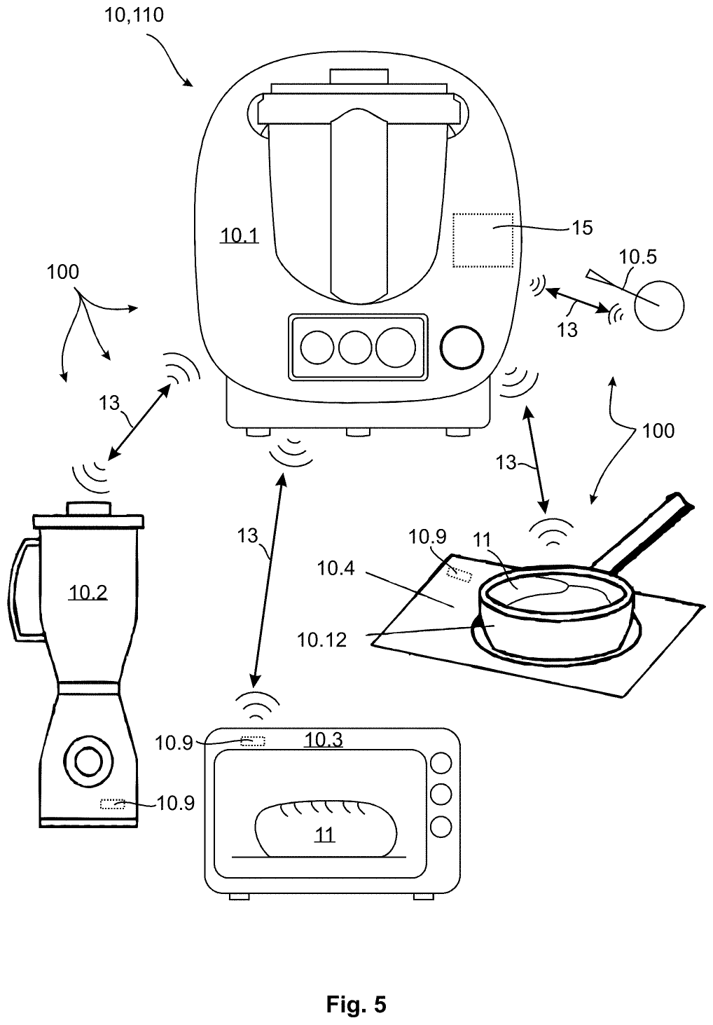

FIG. 5 Schematic diagram of the entire kitchen appliance system with various kitchen appliances,

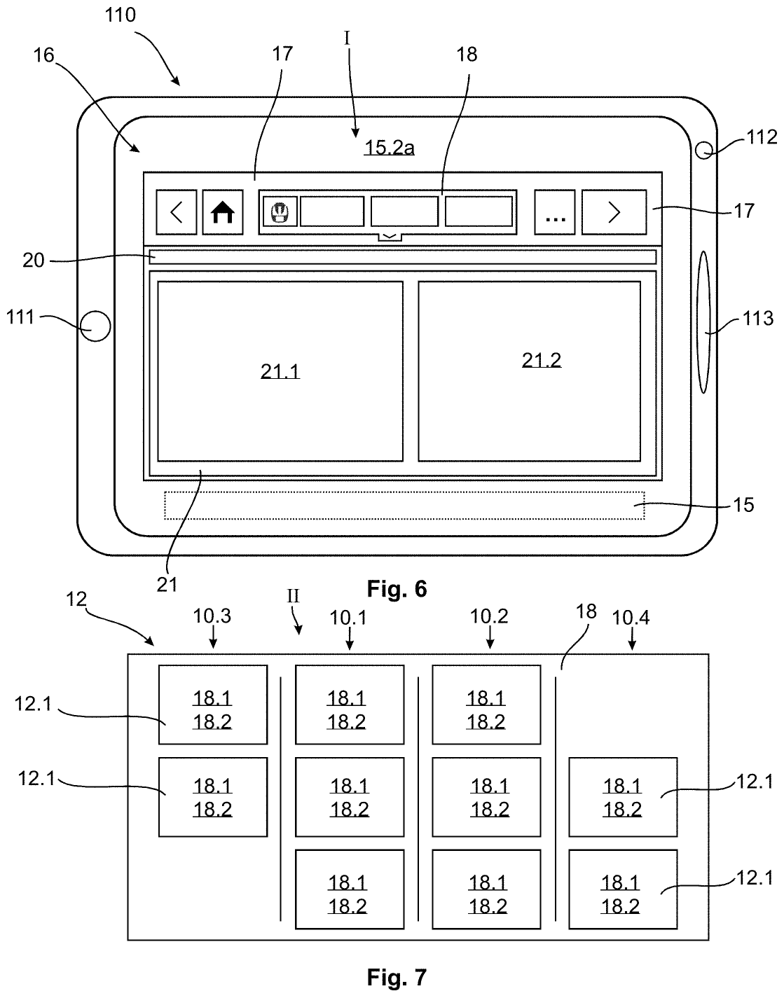

FIG. 6 Schematic representation of a further device according to the invention, in the form of a tablet with an (integrated) central control device and the user interface for controlling the process, and

FIG. 7 Schematic representation of the unfolded overview panel (of a recipe) with arrangement of the panels for the respective kitchen appliances with device names and parameters according to a Kanban representation.

In the following figures, the identical reference signs are used for the same technical features even of different embodiments.

FIG. 1 shows a schematic user interface 16 of a central control device 15 for display and control of the method according to the invention for automatic processing of at least one working stage 12.1 of a recipe 12 for preparation of a food 11. This user interface 16 is shown on a display 15.2b of a user input device 15.2 (as shown in FIGS. 4 and 5). The user interface 16 has several areas or panels, which are divided into a main information panel 17, an overview panel 18, which is an unfold panel, at least one control panel 19, a recognition panel 20, and a control panel 21. Thereby, these panels can be arranged next to each other on the user interface 16 to provide a good overview for the user.

The main information panel 17, which is preferably arranged horizontally in the upper area of the user interface, is subdivided into individual control panels 19, such as an input key back 19.5, an input key forward 19.6, an input key option 19.7 and/or an input key home 19.8. Furthermore, the overview panel 18 is also arranged in the main information panel 17 in the folded state I (see FIG. 1). Thereby, at least the current parameters 10.8 (in panels 18.1 for the parameters) of the current kitchen appliance 10 are visible in the folded overview panel 18 (see FIG. 8). This gives the user a direct overview of which parameters 10.8 of the currently active kitchen appliance 10 are present. For the parameters 10.8, both the preset target values and the actual values for the respective appliance function 10.7 can be displayed (see FIGS. 8 and. 9). The device function 10.7 can be symbolized by icon 25 to get a better overview. Likewise, an icon 22 for the respective active kitchen appliance 10 can also be displayed in the folded overview panel 18, preferably at the left edge of the overview panel 18.

As can be further seen from FIG. 1, there is preferably a recognition panel 20 below the main information panel 17, in which the device name of the current kitchen appliance 10 can be displayed. Also, this recognition panel 20 can indicate the respective working stage 12.1 from the recipe 12. In the control panel 21, which is preferably arranged below the recognition panel 20, the current state of the current kitchen appliance 10 is displayed, wherein also an instruction for the current working stage 12.1 is indicated for the user. For this purpose, the control panel 21 can be divided into a status panel 21.1 (for the kitchen appliance with its parameters) and an instruction panel 21.2 (for a work instruction for the user), as shown in FIGS. 1 to 3.

The special feature of the folded overview panel 18 is now that the current device function 10.7 of the current kitchen appliance 10 with its parameters 10.8 are displayed directly without any action on the part of the user. Thereby, the user can select and prioritize the (automatically changing) display of the corresponding kitchen appliance 10 on the basis of his specifications via a first mode, as already listed. Thus, the user immediately receives the information which kitchen appliance 10 is currently active and what the exact state of the executed and current appliance function 10.7 looks like in detail. If, for example, a warm indication occurs with one of the kitchen appliances 10 from the appliance list, this goods indication can cause the unfolded overview panel 18 to immediately display the kitchen appliance 10 with the warning indication in the overview panel. It is also conceivable that the overview panel automatically unfolds as a result of this warning notice in order to display the current kitchen appliance 10 with the warning notice, preferably at the top.

To provide the user with an overview of all kitchen appliances 10 from the appliance list of the kitchen appliance system 100, he can switch to the unfolded overview panel 18 (from FIG. 2) by selecting and activating the folded overview panel 18 (from FIG. 1). In the unfolded state II of the overview panel 18 the respective kitchen appliance 10 from the appliance list with its appliance function 10.7 and its appliance parameters 10.8 is now displayed—in the present case line by line one below the other. If the size of the user interface 16 is not suitable for complete display of the unfolded overview panel 18, a scroll bar 19.2 can be provided for scrolling the kitchen appliances 10 displayed line by line in the unfolded overview panel 18. In order to provide an optimal overview for the user, in each line for a kitchen appliance 10 both an icon 22 for the kitchen appliance is symbolically represented and an appliance name in the panel 18.2 as well as the parameters 10.8 in the panels 18.2 to represent the current state. The icons 22 used provide an intuitive overview for the user of the respective kitchen appliances 10 in the respective row from the unfolded overview panel 18. In this context, it is also conceivable that the existing kitchen appliances 10 are sorted or grouped in the second modes (1. to 5.) already mentioned in the list shown. In FIG. 3, for example, a bar for marking 24 the two additional thermometers 10.5 is shown as one type of device. As has been mentioned, another grouping or sorting can also be achieved by the adjustable modes.

An activation marker 23 can be provided so that the user can intuitively determine which kitchen appliance 10 is currently active or requires a manual action or has sent out a warning message, even when the overview panel 18 is unfolded. This activation marker 23 may, for example, consist of a symbol, such as an asterisk (“*”) in the present case (see FIGS. 2 and 3). Also, the icon 22 itself can serve as an activation marker 23, for example by an inversion of the icon 22, as shown in FIG. 3, to the additional thermometer 10.5, see the last two lower icons 22 in the list of the unfolded overview panel 18. Alternatively, the kitchen appliance 10 that requires a manual action could be at the top in the unfolded state (II) of the overview panel 18 or in the second position, since the main appliance 10 (kitchen appliance 10 defined by the user) is always displayed in the first position, if applicable.

It is also clear from both FIGS. 2 and 3 that the unfolded overview panel 18 at least partially overlaps the underlying control panel 21, so that areas of the control panel 21 that have not been overlapped are still visible, however. These underlying areas can also be set off by color or brightness to improve the overview.

In the control panel 21 of FIG. 1, the current state of the respective kitchen appliance 10 is shown in the status panel 21.1 and the next, here manual, stage 12.1 involves the addition of 200 grams of water, which is shown in the instruction panel 21.2.

FIG. 2 shows an example of the overview panel 18 in the unfolded state II, in each case with the kitchen appliances 10 from the appliance list shown in detail line by line. By selecting and activating a kitchen appliance 10 (in the respective line), the user can immediately switch to this appliance 10, which is then displayed accordingly in the control panel 21. In the case of the last two kitchen appliances 10, meaning the two appliances from the last two lines, namely the microwave oven and the electric pan, the name or designation and the current parameters 10.8 relating to the kitchen appliances 10 are displayed in detail. According to this, the microwave oven 10 (penultimate line) with the designation “MW turbo 7” has a heating process with circulating air by a fan with level 2 at currently 123° C. (actual temperature), whereby the set temperature is set to 160° C. The heating process of the furnace is to continue for another 4 min (remaining time). The electric pan 10 from the last line of the overview panel 18 is labeled “Pan X”. The current actual temperature is 140° C. and has thus reached the preset target temperature of 140° C. The remaining time of the frying process is displayed as 17 min. In FIG. 2, the displayed kitchen appliances 10 are not sorted by appliance class, as can be seen from the different appliance symbols on each line.

As has been mentioned before, the respective kitchen appliances 10 can be grouped according to appliance classes and displayed line by line (in the overview panel 18 in the unfolded state II) (see FIG. 3—last two lines). The appliance classes include, among others, partially automated and fully automated cooking mixers, ovens, simple cooking and stirring appliances (with a reduced range of functions, e.g. purely manual operation of the working stages), pans or temperature sensors, which can be identified and grouped via a (appliance class) icon. There may be several (similar) kitchen appliances 10 per appliance class, which may be arranged, for example, line by line or area by area and also depending on the runtime from left to right. In the first line, for example, a partially automated and fully automated cooking mixer is indicated by a (device class) icon 22. This icon 22 can simultaneously serve as an activation marker 23, in which it is displayed, for example, with a different color or inversely to the other icons 22. The activation marker 23 for a kitchen appliance 10 may also comprise a separate symbol or icon (here “*”), as mentioned above. In the last two lines of the unfolded overview panel 18, two additional thermometers are shown grouped into a device class adjacent to and below each other. By grouping them into device classes, an optical affiliation can also be established for the user in a simple manner, which can additionally be visually emphasized by a marking 24, for example, in the form of a bar or a border, etc.

In order to facilitate the overall control of the method according to the invention, the control panels 19 are provided in the main information panel 17. Through this, it is possible to either go forward or backward in the recipe 12 through the respective control panels, or to jump to the starting point through the home key, or to select various options through the option key (e.g. selection of the mode).

FIG. 4 shows a device 110 according to the invention in the form of a kitchen appliance 10. This kitchen appliance 10 is designed as a kitchen appliance 10.1 with complex functions. The individual appliance functions 10.7 include, for example, appliance function 10.7a as a stirrer, appliance function 10.7b as a heater, appliance function 10.7c as a scale, and appliance function 10.7d as a heater. In addition, there may be other device functions 10.7, but these are not shown in FIG. 4. Furthermore, the device 110 has the central control device 15 to be able to monitor and control the kitchen appliance system 100 as a whole. For this purpose, a data memory 15.1 is provided, as well as user input device 15.2 and interface 15.3, and a data processing unit 15.4. The present method may be stored as a computer program (product) in the data memory 15.1 and is processed by the data processing unit 15.4. The user input device 15.2 may have a multi-part design, namely a display 15.2a and a multi-function knob 15.2b. Advantageously, the user input device 15.2 itself is designed as a touch screen. However, insofar as a display 15.2a without touch function is used, a cursor can be used to select and activate a control panel 19 or other panel of the user interface 16. The cursor can be controlled here, for example, by the multifunction knob 15.2b, whereby the multifunction knob 15.2b itself can be designed to be rotatable, pivotable and pressable.

FIG. 5 shows a complete kitchen appliance system 100 with various kitchen appliances 10. The process according to the invention takes place on the device 110, which is shown as a kitchen appliance 10 with complex functions. In the kitchen appliance system 100, there is also provided, for example, a kitchen appliance 10.2 in the form of a blender, a kitchen appliance 10.3 in the form of an oven, a kitchen appliance 1.4 in the form of a stove, and a kitchen appliance 10.5 in the form of an auxiliary thermometer. Of course, other kitchen appliances 10 (having different or similar appliance functions) may be present with this system 100. The respective kitchen appliances 10 communicate with the device 110 according to the invention via data connections 13, which are preferably designed as wireless connections. For this purpose, the respective kitchen appliances 10 each have a (data) interface, which may be designed as a WLAN or WiFi or UWB or Bluetooth interface or other short-range radio technologies or local wireless network connections. In the kitchen appliance 10.3, which is designed as an oven, a food 11 is also shown, just as in the pan 10.12 of the kitchen appliance 10.4 in the form of a stove.

The special feature in the present kitchen appliance system 100 is now to be seen in the fact that this is at least partially automatically actuated and controlled by the process according to the invention (with all kitchen appliances 12) on the basis of a selected recipe 12. In order to provide the user with an intuitive and optimal overview of the respective situation and state of the process, the corresponding user interface 16 is provided.

Instead of the kitchen appliance 10.1 with complex function (from FIGS. 4 and 5), a device 110, such as the tablet from FIG. 6, can also serve. In this case it is advantageous that the central control device 15 with its further elements is already completely integrated in such a tablet. Also, in the case of a tablet, the user input device 15.2 is present in order to map the user interface 16, as already mentioned. Since usually such a device 110 also has a camera 112 and a speaker 113, as well as a key 111 if necessary, other functions such as online help or participation in a chat room can also easily take place.

FIG. 7 shows, for example, an overview panel 18 in the unfolded state II in a block display (kanban display), where the respective kitchen appliances 10.1 are each shown in a block with the respective appliance names 18.2 and the current parameters 18.1. This allows a user to directly obtain a comprehensive overview of the respective kitchen appliance 10 with the (next to be executed) working stages 12.1 from the recipe 12.

In FIGS. 1 and 2, exemplary details of the user interface 16 are shown for better understanding. In particular, the overview panel 18 in the folded state I with the respective parameters 18.1 is shown in detail in FIG. 1. Then, a cooking process of 9 minutes takes place, where the set target temperature is 100° C. and the current actual temperature has reached 43° C. At the same time, a stirring process takes place in stage 3 in the kitchen appliance 10.

The foregoing explanation of embodiments describes the present invention solely in the context of examples. Individual features of the present invention can also be freely combined with one another within the scope of the claims, provided that this is technically expedient.

### LIST OF REFERENCE SIGNS

10 Kitchen appliance, especially with central control devices
10.1 Kitchen appliance, especially with complex functions
10.2 Kitchen appliance, especially blender
10.3 Kitchen appliance, especially oven
10.4 Kitchen appliance, especially stove
10.5 Kitchen appliance, especially additional thermometer
10.7 Appliance function
10.7a Appliance function as stirrer
10.7b Appliance function as heater
10.7c Appliance function as a scale
10.7d Appliance function as heater
10.8 Parameters, in particular setpoint and/or actual value
10.9 Interface from 10
10.10 Container for 11
10.11 Lid for 10.10
10.12 Pan/pot
12 Food
12 Recipe
12.1 Working stages from 12
13 Connection (via interface)
15 Central control device
15.1 Data storage
15.2 User input device
15.2a Display
15.2b Multifunction knob
15.3 Interface from 15
15.4 Data processing unit, in particular microprocessor
16 User interface
17 Main information panel
18 Overview panel, foldable and unfoldable
18.1 Parameter panel
18.2 Panel for device name
19 Control panel
19.1 Input key
19.2 Scroll bar
19.5 Input key back
19.6 Input key forward
19.7 Input key Option
19.8 Input key Home
20 Recognition panel
21 Control panel
21.1 Status panel for 10
21.2 Instruction panel for working stage
22 Icon for 10
23 Activation marker, especially for 10
24 Marking
25 Parameter icon
100 Kitchen appliance system
110 Device
111 Key
112 Camera
113 Speaker
120 Computer program product
I Folded state of 17
II Unfolded state of 17

1. A method for controlling a kitchen appliance system, for automatically processing at least one working stage of a recipe for preparing a meal, with the aid of a central control device having at least one user input device and an interface,
wherein the kitchen appliance system comprises at least two kitchen appliances registered in an appliance list and
each kitchen appliance from the appliance list has an interface, whereby it can be controlled by the central control device,
wherein each kitchen appliance has at least one appliance function which is at least selectable or adjustable by at least one parameter in order to perform at least one working stage from the recipe for the preparation of the food automatically by the respective appliance function of the kitchen appliance,
wherein
the user input device has a user interface for displaying and controlling the method, wherein the user interface comprises at least one foldable and unfoldable overview panel, which, in the folded state of the overview panel, displays parameters of a kitchen appliance of the kitchen appliance system, and
in an unfolded state of the overview panel displays at least partially or the entire appliance list of the kitchen appliance system, wherein parameters of at least each active kitchen appliance with the respective appliance function are displayed.

2. The method for controlling according to claim 1,
wherein
in the folded state of the overview panel of only one kitchen appliance of the kitchen appliance system exclusively parameters about at least one current appliance function is displayed and
in an unfolded state of the overview panel, the appliance list of the kitchen appliance system is displayed, each kitchen appliance from the appliance list being symbolized with an icon and having an equipment name.

3. The method for controlling according to claim 1,
wherein
for each kitchen appliance in the appliance list at least one activation marker is displayed in the foldable and unfoldable overview panel, the activation marker indicating whether at least
the kitchen appliance is switched on or off
the kitchen appliance can at least be reached or controlled by the method at least one appliance function of the kitchen appliance is active.

4. The method for controlling according to claim 1,
wherein
a change between the folded and the unfolded state of the overview panel takes place by means of an activation,
wherein the activation is controllable by at least a manual selection or a trigger signal or by an incoming warning signal from a kitchen appliance or time-dependent.

5. The method for controlling according to claim 1,
wherein
several kitchen appliances are combined into at least one appliance class.

6. The method for controlling according to claim 1,
wherein
in the folded state of the overview panel the displayed kitchen appliance is displayed by a first mode adjustable by the user or predefined and in the unfolded state of the overview panel the appliance list can also be displayed in a second mode adjustable by the user or predefined, wherein the order of the kitchen appliances in a
1. Mode the appliance by appliance classes,
2. Mode the appliance according to their activity
3. Mode the appliance according to a prioritization,
4. Mode the appliance according to a (time) sequence of the next working stages from the recipe and
5. Mode the appliance after a warning signal are displayed.

7. The method for controlling according to claim 1,
wherein
the user interface also has at least one control panel for at least one appliance function of the kitchen appliance in addition to the overview panel which can be folded and unfolded.

8. The method for controlling according to claim 1,
wherein
the user interface of the user input device displays individual panels which simultaneously at least serve as input keys or scroll bars for controlling the method by the central control device,
whereby at least one device function of a kitchen appliance is triggered on the basis of entered parameters which have been entered with the aid of the user interface.

9. The method for controlling according to claim 1,
wherein
the user interface has a main information panel with control panels for the method, the overview panel being integrated in the main information panel in the folded state, and wherein the control panel is displayed together next to the main information panel.

10. The method for controlling according to claim 9, wherein
the overview panel in the unfolded state at least partially overlaps the control panel in order to be able to select the kitchen appliance to be controlled from the appliance list.

11. The method for controlling according to claim 1,
wherein
the interface of the respective kitchen appliance is configured as a wireless interface.

12. A device for controlling a kitchen appliance system, for automatically executing at least one working stage of a recipe for preparing a meal, having a central control device, and at least one user input device and one interface,
wherein the central control device is adapted to perform the method according to the preceding claims.

13. The device of claim 12,
wherein
the device itself is configured as a kitchen appliance and
the kitchen appliance comprises at least
a container for the preparation of the food,
an agitator which projects into the container, and
the central control device with at least the user input device and the interface.

14. The device of claim 12,
wherein
the device itself is configured as a computer, laptop, tablet, smart phone or smart TV.

15. A computer program product comprising instructions which cause the device according to claim 12 to execute the method.

16. The method for controlling according to claim 2,
wherein
the exclusively parameters are:
Time information, about the remaining time of the appliance function
Temperature, setpoint or actual temperature
Weight or type of food
Stirring function, stirring stage or speed
Heating operation at the oven
Moisture specification
Fan operation
Filling level
Consumption level etc.

17. The method for controlling according to claim 2,
wherein
parameters of each kitchen appliance with the respective appliance function are displayed section by section at the same time.

18. The method for controlling according to claim 4,
wherein
at least an incoming trigger signal or warning signal from a kitchen appliance changes the overview panel in such a way, that the corresponding kitchen appliance is displayed with a warning.

19. The method for controlling according to claim 7,
wherein
the control panel of the kitchen appliance and the folded overview panel are displayed simultaneously.

20. The method for controlling according to claim 11,
wherein
the interface is configured as a short-range radio technology interface or local wireless network connection interface, wherein a protected encrypted data exchange takes place via the interfaces.
